(19) United States
(12) Patent Application Publication
(10) Pub. No.: US 2005/0287958 A1
(43) Pub. Date: Dec. 29, 2005

(54) Connecting device for wireless communication

(75) Inventors: Chia Jui Sheng, Taipei (TW); Shun Cheng Lin, Taipei (TW)

Correspondence Address: BACON & THOMAS, PLLC, 625 SLATERS LANE, FOURTH FLOOR, ALEXANDRIA, VA, 22314, US

(73) Assignee: North Star Systems Corp., Taipei (TW)

(21) Appl. No.: 10/876,451

(22) Filed: Jun. 28, 2004

(51) Int. Cl. H04B 1/38; H04B 1/40; H04Q 7/20

(52) U.S. Cl. 455/88; 455/73

(57) ABSTRACT

This invention is a connecting device for wireless communication. The said connecting device is primarily installed in a mobile phone to enable transmission and reception of message between both sides for communicating, in which the said connecting device utilizes the connecting technology of the Bluetooth or the public channel to enable end-to-end connection or multipoint connection, and thereby to enable transmission and reception of message. It also allows allocating an independent base station on a car or at a fix location for receiving and transferring message to relax the distance constraint of wireless communication and to support the function of hands-free.

### BACKGROUND OF THE INVENTION

1) Field of the Invention

The present invention relates to a connecting device for wireless communication, more particularly to an additional connecting device, by way of the microphone and speaker devices of a mobile phone, enabling the transmission and reception of message between both sides for communicating.

2) Description of the Prior Art

The convenience of daily life for average people has been greatly enhanced with the introduction of mobile phone. As a contemporary person, all of us are benefited by the prevalence of mobile phones. Accordingly, the industries are drawn to be devoted to develop and improve that product as well as its peripheral equipments, in order to create a product that is more convenient and is correspondent to the human nature.

Moreover, many electronic products are stepping into the era of wireless communication in accordance with the advance of the technology of wireless communication. The connecting technology of wireless communication for the electronic products around our lives, such as wireless keyboards, mice, telephones, ear phones, microphones, wireless LAN's, and wireless printers, etc, have been developed. It is obvious that the purpose of developing wireless communication is to relax the environmental and spatial constraints exerted on both sides for communicating.

Because of the convenience brought by the mobile phones, both the population and the frequency of using a mobile phone are increasing year after year. The reason is that the people have been accustomed to communicate with others at any time and in any place. However, to connect two point apart by a short distance using the mobile phone, it is necessary to dial for both sides to connect each other, the calling fee will be a significant load for the user.

### SUMMARY OF THE INVENTION

In view of the problems stated above, the present inventor, in the light of research experience on wireless communication over the years, expected to apply the technology of wireless communication to the mobile phone, likewise. The main purpose is to provide a device such that both sides for communicating, at a properly effective distance, can directly communicate utilizing the originally existing device. Accordingly, the functions of the mobile phone will be extended, and the cost of calling fee will be significantly decreased.

### BRIEF DESCRIPTION OF THE DRAWINGS

FIG. 1 is an assembly drawing of the present invention.

FIG. 2 is a block diagram showing the architecture of the present invention.

FIG. 3 shows the usage of the present invention.

FIG. 4 shows the connection between the present invention and the base station.

FIG. 5 is a block diagram showing the architecture of the base station according to the present invention.

FIG. 6 shows an embodiment according to the present invention.

FIG. 7 shows another embodiment according to the present invention.

FIG. 7 shows further another embodiment according to the present invention.

### DETAILED DESCRIPTION OF THE PREFERRED EMBODIMENTS

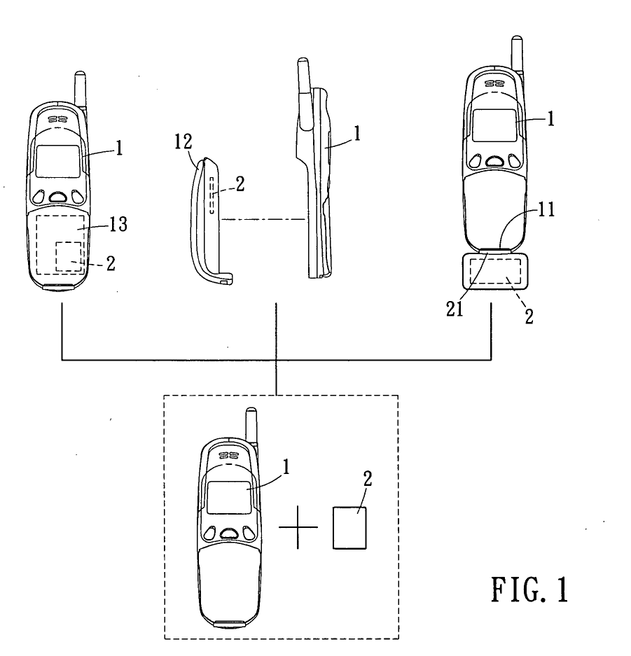

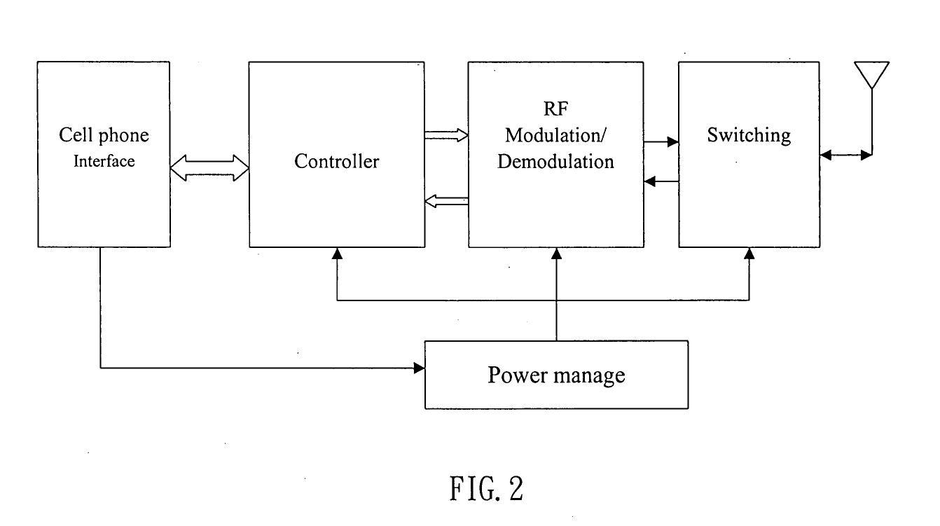

Referring to FIG. 1 and FIG. 2, the connecting device for wireless communication according to the present invention is mainly installed inside a mobile phone 1 such that, by way of the original microphone and speaker devices inside the mobile phone 1, both sides for communicating can transmit and receive message. To connect the mobile phone 1 and the device 2, there exist at least three embodiments:
(1) The connecting device 2 is connected to the socket 11 of a mobile phone 1 by way of a connector 21, which is an embodiment specialized for extending the functions of a conventional mobile phone 1.
(2) The connecting device 2 is fitted into the battery 12, which is also an embodiment specialized for extending the functions of a conventional mobile phone 1.
(3) The connecting device 2 is directly integrated into the circuit board 13 of a mobile phone 1, which is an embodiment specialized for embedding the connecting device during the manufacturing process of a new type mobile phone in the factory.

For the connecting device 2 installed in a mobile phone 1, the said connecting device 2 at least comprises a controller, an RF modulation/demodulation block, a switching block, and a power manage block, in which the power manage block is connected to the battery of the mobile phone such that the power of the whole connecting device 2 is supplied by the mobile phone 1.

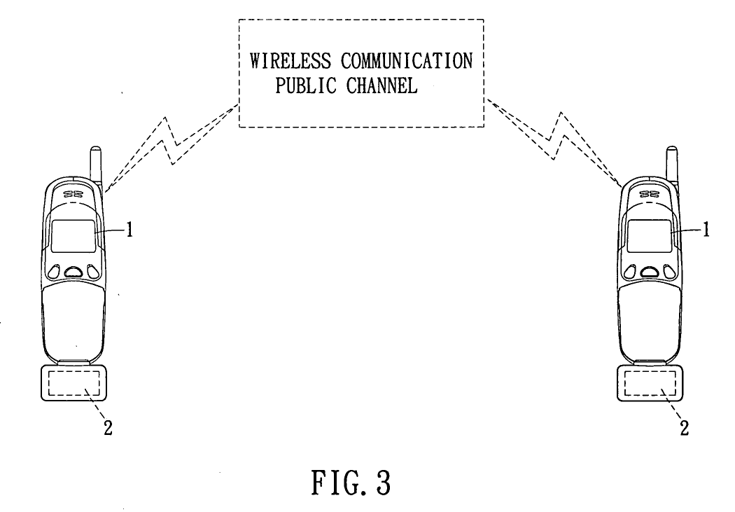

Furthermore, referring to FIG. 3, when the connecting device 2 for wireless communication according to the present invention is installed in a mobile phone, the connecting device 2 can use the connecting technique of wireless public channel, such as FM, Bluetooth, FSK, etc., as a bridge to perform data transmission and reception. After transforming the transmitted and received data by way of encoding and decoding, the data can be transformed into associated multimedia data, such as sound, text, music, or graphics, to complete the transmission.

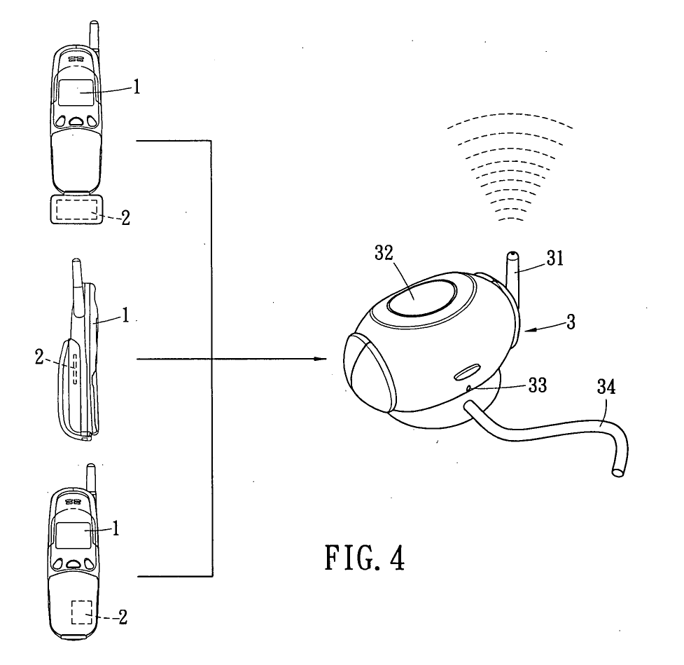

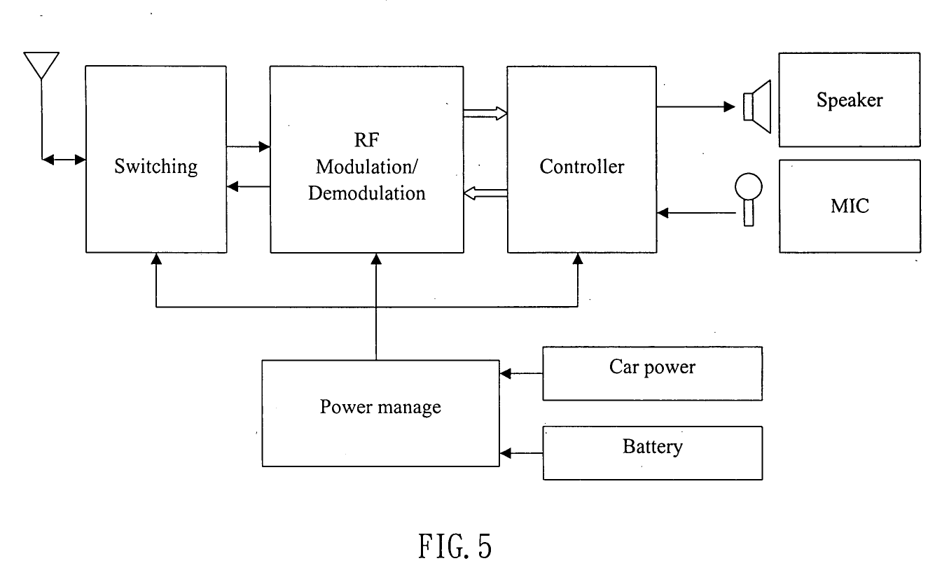

Moreover, referring to FIG. 4 and FIG. 5, after the connecting device 2 is connected to a mobile phone 1, it is able to utilize an independent base station 3 to receive and transfer message, in which the said base station 3 is disposed with a duplex antenna 31, a speaker 32, a microphone 33, and a power cord 34, which are provided mainly for car usage. Therefore, the base station 3 comprises at least a controller, an RF modulation/demodulation block, a switching block, a speaker 32, a microphone 33, and a power manage block, in which the power manage block can be connected to the car power or an external battery in order to use the car power or the power of external battery as the power of the whole base station 3. Also, the said base station 3 can utilize the connecting technique of Bluetooth or the public channel, either to connect mobile phone 1, or to connect another base station 3, such that the message can be transmitted to the base station 3 at the opposite side, and then transferred to the mobile phone 1 carried by the user, thereby to perform message transmission and reception of end-to-end or multi-point connection.

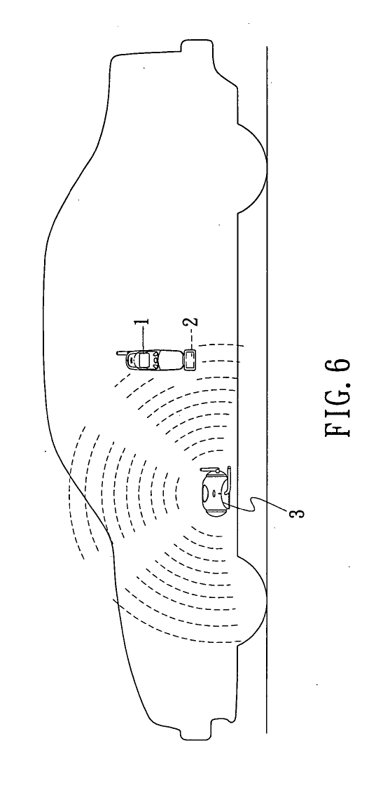

In terms of the contemporary technology of wireless communication, automotive industry is the pioneer that brings in Bluetooth devices, At present many newly-produced car have adopted Bluetooth as a standard interface for hands-free car kit. Likewise, referring to FIG. 6, the present invention installed the connecting device 2 in a mobile phone 1 such that, when the user is driving a car or entering into an effective connecting distance of the base station 3, the mobile phone 1 carried by the user will actively utilize the connecting device 2 to connect base station 3 by way of the connecting technology of Bluetooth or the public channel. Hence the user do not have to talk in a manner of hands-hold when receiving a phone call, in which the output sound of the dialog can be played by the speaker 32 of the base station 3, and the respondent sound is sent in through microphone 33. Thereby, the distance constraint of wireless communication is relaxed and the function of hands-free is provided to the user.

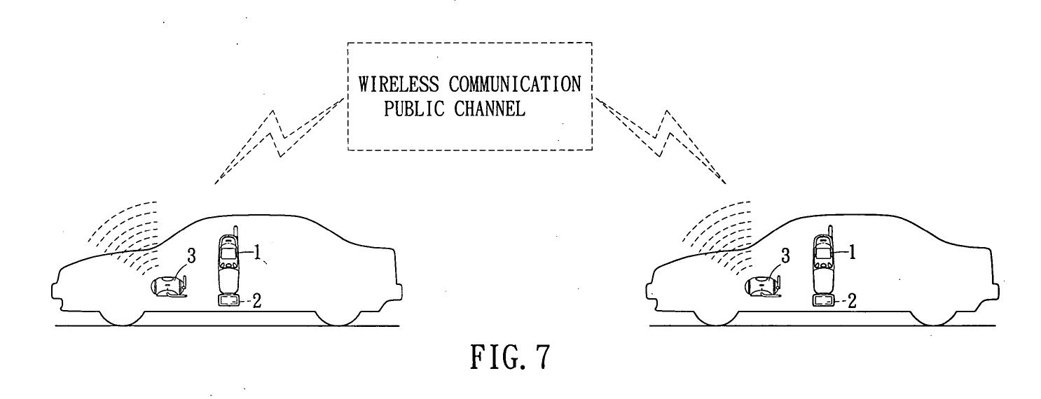

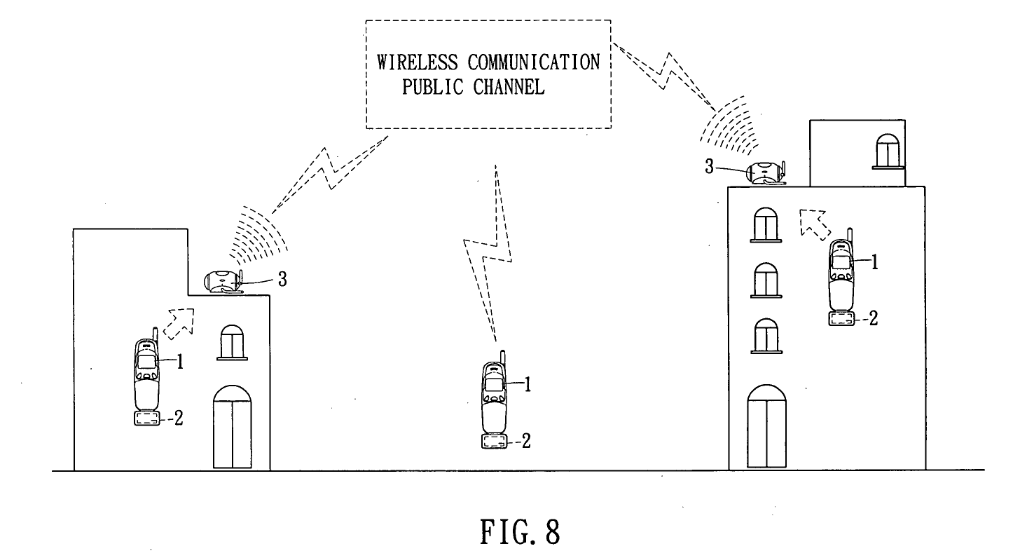

Moreover, referring to FIG. 7, an embodiment showing two user using the present invention, in which assuming that the user is driving, after the mobile phone 1 and the connecting device 2 is connected to the base station 3, the base station 3 which is independent to both sides can connect both sides by way of the connecting technology of Bluetooth or the public channel, such that the driver of both cars can talk or transmit data without dialing the mobile phone, in which the output sound of the dialog can be played by the speaker 32 of the base station 3, and the respondent sound is sent in through microphone 33. Thereby, the function of hands-free is available to the user.

Further, the base station 3 can be installed either in a car or at a fixed location, as shown in FIG. 8, in which the user can install an independent base station 3 at the residential building in accordance with the usage to receive and transfer message. Therefore, in an effective distance, by way of the connecting technology of Bluetooth or the public channel, the user can talk using his personal mobile phone 1. In this way, the function of the mobile phone is extended, and the calling fee is significantly decreased.

1. A connecting device for wireless communication, the said connecting device mainly utilizes the connecting technology of the public channel to perform transmission and reception of message by way of end-to-end or multi-point connection, in which the main features include:
the said connecting device at least comprises a controller, an RF modulation/demodulation block, a switching block, and a power manage block, in which the power manage block is connected to the battery of the mobile phone such that the power of the whole connecting device is supplied by the power of the mobile phone;
such that, after installing the connecting device into the mobile phone, both sides for communicating can connect to each other by directly utilizing the original devices, thus significantly decrease the cost of calling fee;

2. A connecting device for wireless communication according to claim 1, wherein the said connecting device is connected to a socket of the mobile phone by way of a connector, which is a design aiming to extend the functions of a conventional mobile phone;

3. A connecting device for wireless communication according to claim 1, wherein the said connecting device is fitted to the battery of the mobile phone, which is also a design aiming to extend the functions of a conventional mobile phone;

4. A connecting device for wireless communication according to claim 1, wherein the said connecting device is directly integrated into the circuit board of the mobile phone, which is a design aiming to embed the connecting device during the manufacturing process of a new type mobile phone in the factory;

5. A connecting device for wireless communication according to claim 1, wherein the said connecting device can be a base station and the said base station is a transmitter/receiver;

6. A connecting device for wireless communication according to claim 1, wherein the base station at least comprises a duplex antenna, a speaker, a microphone, and a power cord, such that both sides for communicating can perform end-to-end or multi-point connection, and thus perform message transmission and reception;

7. A connecting device for wireless communication according to claim 5, wherein the base station at least comprises a duplex antenna, a speaker, a microphone, and a power cord, such that both sides for communicating can perform end-to-end or multi-point connection, and thus perform message transmission and reception;

8. A connecting device for wireless communication according to claim 1, wherein the base station is installed either in a car or at a fixed location to transmit and receive message, thereby to provide connection between two driver.

9. A connecting device for wireless communication according to claim 5, wherein the base station is installed either in a car or at a fixed location to transmit and receive message, thereby to provide connection between two driver.
